(19) United States
(12) Patent Application Publication
(10) Pub. No.: US 2015/0064397 A1
(43) Pub. Date: Mar. 5, 2015

(54) COMPOSITE FOAM LAMINATE AND ITS USAGE

(71) Applicant: Agency for Science, Technology and Research, Singapore (SG)

(72) Inventors: Yew Wei Leong, Singapore (SG); Yongzheng Pan, Singapore (SG); Pin Lu, Singapore (SG); Chaobin He, Singapore (SG)

(21) Appl. No.: 14/470,447

(22) Filed: Aug. 27, 2014

(30) Foreign Application Priority Data
Aug. 27, 2013 (SG) 201306462-1

(51) Int. Cl. B29C 70/68; B29C 37/00; B32B 3/26; B32B 5/18; B32B 7/12; B32B 27/38; B29C 70/44; B29C 70/54

(52) U.S. Cl. CPC B29C 70/68; B29C 70/443; B29C 37/0075; B29C 70/545; B32B 5/18; B32B 7/12; B32B 27/38; B32B 3/266; B29K 2063/00
USPC 428/137; 264/511; 428/304.4; 428/317.7; 428/319.3

(57) ABSTRACT

The present disclosure relates to a laminate for making a molded article comprising at least one fiber reinforcement impregnated with a resin matrix as a first layer and a foam as a second layer. The foam can be laminated to the first layer using a nanocomposite adhesive. The laminates can be easily molded using bagging mold techniques. The resulting molded devices have uses in biomedical, health care and sport protective devices. Due to the improved strength of material, it is possible to drill holes into the device shell allowing for improved ventilation.

### CLAIM OF PRIORITY

This application claims the benefit of priority of Singapore Patent Application Serial No. 201306462-1, entitled “A COMPOSITE FOAM LAMINATE AND ITS USAGE,” filed on Aug. 27, 2013, the benefit of priority of which is claimed hereby, and which is incorporated by reference herein in its entirety.

### TECHNICAL FIELD

The present invention generally relates to laminates for making molded articles. The present invention also relates to the use of the molded articles made from the laminates as biomedical, health care and sport protective devices.

### BACKGROUND

Molded articles with a foam layer are known and have many applications, such as in the fields of biomedical, health care and sport protective devices. Such applications for instance include those where the molded articles have an inner foam layer and an exterior shell. Such molded articles have a use in the manufacturing of body braces for patients with scoliosis.

Conventionally the material used for the shell part is polypropylene (PP). However, Patients have complained that it is very uncomfortable since both the foam and PP shell are non-breathable. It is also impossible to drill ventilation holes since this will significantly compromise the structural integrity of this material. Therefore, there is a need for a molded article with a foam layer that allows for the drilling of holes to allow for ventilation.

Furthermore, undulations between the foam and PP shell layers are common in those devices due to the low adhesion strength at the interface. In the manufacturing process of the molded articles, layers are normally laid separately onto the mold and then laminated via the application of heat and pressure, i.e. partial melting of the materials at the interface to form physical bonds. These bonds are weak, which causes the foam to delaminate from the shell after being worn for extended periods.

During manufacturing of the body brace or similar molded articles with a foam layer, the foam layer has to be initially wrapped around a polyurethane mold. Next, a sheet of PP that has been pre-heated in an oven to about 120° C. and softened to a pliable state will be wrapped around the foam layer and formed as quickly as possible before the sheet becomes too cold and rigid. The assembly is then vacuum bagged to complete the forming process. This process involves many steps and requires skillful craftsmen to be able to form the brace accurately and effectively. Thus, the productivity in the manufacturing of such molded articles is not high.

Therefore, there is a need for a material that allows for an easier way of making such molded articles which additionally shows an improved adhesion of the foam to the article.

As such, there is a need to provide materials to make molded articles that overcome, or at least ameliorate, one or more of the disadvantages described above.

### SUMMARY

In a first aspect, there is provided a laminate for making a molded article comprising at least one fiber reinforcement impregnated with a resin matrix as a first layer and a foam as a second layer.

The laminate is a pre-impregnated reinforced fiber layer laminated to a foam. Advantageously, the laminate is drapable and can be used easily to form a molded article with fewer process steps and without the need of special skills. For the manufacture of the molded article, the laminate can be fastened to the mold at room temperature, vacuum bagged and then left to cure at elevated temperature to yield the appropriate shape. The resulting molded article is thinner, lighter and much stronger than the PP-based articles due to the presence of the reinforcement in the laminate.

The laminate may optionally comprise an adhesive layer between the foam layer and the first layer. In this case molded articles can be made that show very good adhesion of the foam to the reinforced layer and better resistance against wear issues from extensive use of the molded article.

In a second aspect, there is provided a process for making the laminate which comprises the following steps:
(a) immersing the fiber reinforcement into the resin matrix,
(b) impregnating the reinforcement,
(c) optionally applying an adhesive to a foam or the impregnated reinforcement, and
(d) attaching the impregnated reinforcement to the foam. These steps can be performed with conventional equipment in a simple way.

In a third aspect, there is provided a process for making a molded article which comprises the following steps:

(a) exposing the laminate according to the invention to a mold of well-defined shape,

(b) applying a pressure to the laminate, and

(c) curing the laminate.

In a fourth aspect, there is provided a molded article that is obtainable by molding a laminate according to the invention or by molding a laminate obtainable by any of the processes according the invention.

Advantageously, such molded articles are of lighter weight when showing the same stability than known molded articles. Therefore they can be used in applications where light weight and high stability are needed. If the molded article is used as a light-weight body brace, it will reduce fatigue to the wearers of the brace who often need to walk long distances or exercise daily.

In addition, the molded article can have holes that are drilled or punctured in it to allow for good ventilation in applications where this is desirable (e.g. braces in sport applications). The holes can be also used for fastening or joining with other articles. Even with holes the molded articles show enough structural integrity and mechanical strength to be used.

The molded article are further showing significant improvements with regard to the adhesion of the foam to the reinforced layer, especially if an adhesive layer is used according to a preferred embodiment of the invention.

In a fifth aspect, there is provided the method of use of the molded articles as a brace for scoliosis, a prosthetic, a sport protector or a safety device. Such devices are showing improved mechanical strength, ability to be punctured with holes and a more resistant against problems of extensive wear.

### DEFINITIONS

The following words and terms used herein shall have the meaning indicated:

The term “laminate” as used herein refers to a composite material consisting of at least two layers. The layers of a laminate can usually be permanently assembled by heat, pressure, welding, or adhesives.

As used herein, the term “molding” refers to a process of manufacturing by shaping liquid or pliable raw materials, such as laminates, using a rigid frame called a mold or a matrix.

As used herein, the term “pre-preg” refers to “pre-impregnated” composite fibers where a matrix material, such as epoxy, is already present. The matrix is only partially cured. As such the pre-preg is called B-Stage material and requires cold storage to prevent complete curing. Hence, composite structures built of pre-pregs will mostly require an oven or autoclave to fully cure them.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−10 of the stated value, and even more typically +/−0.5% of the stated value.

Throughout this specification, unless the context requires otherwise, the word “comprise”, or variations such as “comprises” or “comprising”, will be understood to imply the inclusion of a stated step or element or integer or group of steps or elements or integers, but not to the exclusion of any other step or element or integer or group of elements or integers. Thus, in the context of this specification, the term “comprising” means “including peripherally, but not necessarily solely”.

Throughout this disclosure, certain embodiments may be disclosed in range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a laminate will now be disclosed.

In a first aspect, there is provided a laminate for making a molded article comprising at least one fiber reinforcement impregnated with a resin matrix as a first layer and a foam as a second layer.

The fiber reinforcement can be in the form of woven or knitted fabric, roving or chopped strands. The material of the fiber reinforcement can be chosen from typical solid materials that have a suitable mechanical strength. According to a preferred embodiment of the invention, a laminate wherein the material of the fiber reinforcement is selected from a carbon, glass, para-aramid synthetic (such as Kevlar® or Twaron®) or polymer fibers can be mentioned. According to the invention carbon or glass fibers are most preferred.

The foam according to the invention can be any foam, in liquid or solidified form, formed from polymers. Examples of such polymeric foams include polyethylene foams, ethylene vinyl (EVA) acetate foams, neoprene foams, polyurethane foams, polyvinylchloride foams, polystyrene foams, and polyimide foams. According to a preferred form of the invention, the foam is preferably flexible up to thickness of 10 mm as needed for the molding process. Polymeric foams with closed cell structure are particularly preferred, such as closed cell polyethylene foams, (EVA) ethylene vinyl acetate foams or neoprene foams. Closed-cell foams do not have interconnected pores. When using such closed-cell foams improvements with regard to stability, low moisture absorption, and mechanical strength can be advantageously achieved.

The foam layer usually has a thickness of less than 10 mm, usually from about 0.5 to 20 mm, preferably about 1 to 10 mm and most preferred 2 to 10 mm.

The resin matrix can be widely selected from typical polymer resin matrices that are used for the reinforcement of the fiber materials mentioned above. The polymer in the resin matrix can optionally be used together with suitable solvents, accelerators and /or cross-linking agents. The polymer matrix may additionally comprise a filler. Typical polymer resins that can be mentioned are thermosetting, such as epoxy, polyester- or vinylester, or thermoplastic polymer resins. Preferred are epoxy resins which are low molecular weight pre-polymers or higher molecular weight polymers which normally contain at least two epoxide groups. Epoxy resins that can be particularly mentioned include bis-phenol A epoxy resin, bis-phenol F epoxy resin, aliphatic epoxy resin, such as glycidyl epoxy resins and cycloaliphatic epoxides, and glycidylamine epoxy resin. The epoxy resin can be used together with an accelerator and/or a cross-linking agent and optionally filler in the resin matrix. The cross linking agent can be preferably an amine. The filler can be used to achieve desirable capabilities of the molded article made from the laminate. For instance, a thermal conductive filler can be used to enhance the dispersion of the body heat of a wearer of a molded article on the body; a light reflecting particle can be added for increasing traffic safety of the wearer; a structural rigidity increasing filler can be added for sport equipment.

According to a preferred embodiment of the invention the first layer consists of multiple layers of fiber reinforcement impregnated with the resin matrix. When such multiple layer structure, preferably containing two to ten layers of impregnated fiber layers, most preferably two to 7 layers, is used, an even higher stability may be obtained when laminating them to the foam layer.

According to another preferred embodiment of the invention, the foam layer is laminated to the first layer using an adhesive layer. Such adhesive layer is placed between the foam layer and the first layer. It can increase the binding of the layers. The adhesive used is preferably a nano-silica based nanocomposite. It is especially suited in connection with an epoxy based resin matrix which is not cured yet (wet pre-preg). According to the invention it has been found that such nanocomposite is very compatible with a wet pre-preg. The nanocomposite will cure at higher rate and ensures good adhesion of the foam to the resin matrix layer.

The nano-silica based nanocomposite may be any such nanocomposite. As an example there can be mentioned a nano-silica based nanocomposite that contains surface-modified synthetic SiO₂ nanospheres of very small size (average diameter of about 1 to 50 nm, preferably 10 to 40 nm, most preferred about 20 nm) with a narrow particle size distribution. Preferably the surface of used nano-silica is modified with a silane (such as (3-Aminopropyl)trimethoxysilane or (3-Aminopropyl)triethoxysilane) that shows a benign compatibility with epoxy resin or other used resins.

According to a preferred embodiment, the handling of the laminate according to the invention before the molding process can be facilitated by using a laminate wherein the first layer is lined with a plastic sheet on the side not attached to the foam layer. Additionally or alternatively, the foam layer can be covered with a non-permanent adhesive paper on the side not attached to the reinforced resin layer.

According to another preferred embodiment, the laminate according to the invention has holes. Preferably the holes have a size of about 1 to 10 mm, more preferably about 1 to 5 mm. Holes with a size of about 1, 2, 3, 5, 6, 7, 8, 9 or 10 mm can be particularly mentioned.

The laminate according to this embodiment can be used to make a molded article with holes which allows for good ventilation in applications where such feature is desirable, e.g. body braces that cover larger body parts. Punching the holes in the laminate before curing eliminates the need for drilling holes in the finished molded article which can be tedious in some cases and which may compromise the quality of the holes in other cases. The size to pitch (distance between holes) ratio can be optimized according to stiffness and ventilation requirements.

In a second aspect, there is provided a process for making the laminate which comprises the following steps:

(a) immersing the fiber reinforcement into the resin matrix,

(b) impregnating the reinforcement,

(c) optionally applying an adhesive to a foam or the impregnated reinforcement, and

(d) attaching the impregnated reinforcement to the foam.

In step (a) the fiber reinforcement is immersed into the resin matrix. This means that the fibers are wetted with the resin matrix by suitable means. This process step can be performed at room temperature.

In step (b) the reinforcement is impregnated. This means that the wetting with non-cured resin matrix is further completed. Preferably this impregnation is achieved by passing the reinforcement fibers through rollers. The result of step (b) is a non-cured impregnated layer (wet pre-preg). According to a preferred embodiment two or more layers of wet pre-preg can be laid on the top of each other to form one layer for further processing. Typical weight ratios of the fiber reinforcement material to the resin matrix material to be achieved during impregnation are about 1:10 to 10:1, preferably 5:1 to 1:1. In case of the use of glass fibers a ratio of about 4:1 to 1:1 is particularly preferred. A ratio of about 3:1 can be mentioned.

Process step (b) can be performed at room temperature.

Step (c) is an optional step in this process according to the invention. It can be applied, if an adhesive is used according to a preferred embodiment. In step (c) the adhesive is applied to the foam or the impregnated reinforcement. It has been found according to the invention that the adhesive is preferably applied to the foam before the foam is brought in contact with the wet pre-preg to achieve a strong adhesion. Process step (c) can be performed at room temperature.

In step (d) the impregnated fiber reinforcement is attached to the foam. This step can be performed by laying the pre-preg on the foam. The attachment can preferably be supported by a further step wherein the attached layers are fed through a series of several rollers. Wetting can be completed in this step and the attachment strengthened. All these steps can be performed at room temperature. After these steps the polymer matrix, especially the epoxy, is preferably only partially cured (B-stage material). Advantageously, the partially cured polymer matrix is tacky, but not fluid, and can be well used in the following molding process.

In addition to steps (a) to (d), another step can be added wherein holes are punched or drilled into the obtained laminate. The holes preferably have a size of about 1 to 10 mm, more preferably about 1 to 5 mm. Holes with a size of about 1, 2, 3, 5, 6, 7, 8, 9 or 10 mm can be particularly mentioned.

In a third aspect, there is provided a process for making a molded article which comprises the following steps

(a) exposing the laminate according to the invention to a mold of well-defined shape,

(b) applying a pressure to the laminate, and

(c) curing the laminate.

In step (a) the laminate is exposed to a mold. This exposure can be for instance achieved by wrapping the mold with laminate or laying the laminate into a mold. The mold is a shaped article of well-defined geometry used as a rigid frame for shaping the partially cured and pliable laminate according to the invention.

In step (b) a pressure is applied to the laminate. This step supports the exposure of the laminate to the mold giving it the desired shape before curing into a molded article.

The pressure can be applied in many ways, for example mechanical clamping or stapling. However, it may be preferred to apply a vacuum to achieve the pressure. This technique is well compatible with the reinforced layer laminate according to the invention as it allows for a smooth curing process and shaping of the laminate to various forms by evenly applying the pressure over the mold surface.

According to a preferred embodiment, the vacuum is induced inside a bagging film (bagged vacuum). The bagging film forms a closed bag around the mold and the laminate and can be any airtight film. The vacuum is created by a vacuum pump linked to the bag.

In the vacuum bagging preferably a breather material linked to the vacuum port is used between the bagging film and the laminate. A breather material can be a cloth that allows air from all parts of the bag to be drawn to a port or manifold linked tom the vacuum pump by providing a slight air space between the bag and the laminate. A typical breather cloth is made from polymer fibers, e.g. a polyester cloth.

In another preferred embodiment, a release film is inserted between the breather material and the laminate. Release can be a woven fabric that will not bond to polymer matrix. It is used to separate the breather and the laminate. According to the invention it has for instance be found that excess epoxy can wick through the release fabric. After the curing step (c) the release film can be peeled off. A typical release film could be a polyester fabric.

In step (c) the laminate is cured. Such curing preferably takes place at elevated temperatures, e.g. of about 30 to 140° C., preferably about 80 to 120° C., most preferred about 90° C. It can however in some cases also be performed at room temperature over longer terms.

If desirable for the planned application, a step of drilling or punching holes into the molded article after the curing step can be added. The molded article has enough mechanical stability to allow the use of typical drilling or punching techniques. Preferably the holes have a size of about 1 to 10 mm, more preferably about 1 to 5 mm. Holes with a size of about 1, 2, 3, 5, 6, 7, 8, 9 or 10 mm can be particularly mentioned.

In a fourth aspect, there is provided a molded article that is obtainable by molding a laminate according to the invention or obtainable by any of the processes according the invention.

The molded article has a structure comprising the following layers:

(a) a polymer matrix reinforced by a fiber, and

(b) a foam.

Preferably the polymer matrix forms a shell (or outer skin) that has the foam layer at the inside of the shell (or as an inner lining). It can have holes.

In a fifth aspect, there is provided the corresponding method of using the molded article as a brace for scoliosis, a prosthetic, a sport protector or a safety device.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 shows a schematic representation of the preparation steps to produce a composite foam laminate according to one embodiment of the invention.

FIG. 2 shows a typical vacuum bagging process used to produce a composite brace from the laminate.

FIG. 3 shows stress-strain curves of PP and pre-preg laminate with and without holes.

FIG. 4 shows a schematic showing of a representative area of a plate with periodic circular holes.

FIG. 5 shows the equivalent tensile modulus of pre-preg laminate with periodic holes as a function of a/c.

FIG. 6 shows the equivalent tensile modulus of PP with periodic holes as a function of a/c.

### DETAILED DESCRIPTION OF DRAWINGS

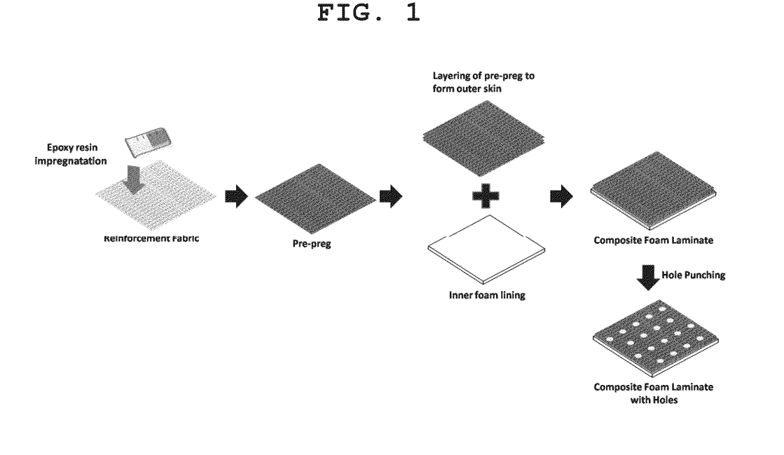

FIG. 1 shows a schematic representation of the preparation steps to produce a typical composite foam laminate. The reinforcement used to prepare the pre-preg can be in the form of a woven or knitted fabric, roving, or chopped strands. The resin matrix is typically bis-phenol A epoxy resin that is mixed with accelerator and an amine-based cross-linking agent. The foam is derived from a polymeric material which is flexible and up to 10 mm thick and additionally has a closed cell structure. To fabricate the laminate, the reinforcement fabric is first immersed into the epoxy resin and then passed through rollers to ensure good impregnation of the resin into the fabric to form a pre-preg. Several layers of fabric can be used to form one impregnated layer. Meanwhile, a layer of nanocomposite adhesive is applied onto the foam before the wet pre-preg is laid onto the foam. The nanocomposite adhesive is compatible with the pre-preg resin and will cure at a higher rate to ensure good adhesion of the foam to the pre-preg. The laminate assembly is then fed through another series of rollers to ensure complete wetting and adhesion of the pre-preg onto the foam surface. A plastic sheet is lined on the fiber side while non-permanent adhesive paper is lined at the foam side for protection and ease handling. The laminate is then allowed to B-stage at room temperature.

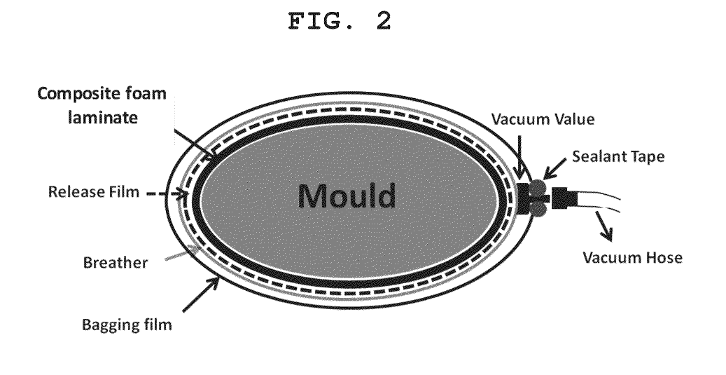

FIG. 2 shows the vacuum bagging molding process that can be used to make the molded articles.

### EXAMPLES

Non-limiting examples of the invention and a comparative example will be further described in greater detail by reference to specific Examples, which should not be construed as in any way limiting the scope of the invention.

### Examples

### Example 1

### Preparation of Pre-Preg Laminate

The epoxy system which consists of resin (Araldite® LY 1556, a medium-viscosity, unmodified epoxy resin based on bisphenol-A curable at 80° C.), accelerator (Accelerator® 1573, a dispersion of dicyandiamide in liquid epoxy resin) and hardener (Hardener XB3471, a polyamnin based hardener) were purchased from Huntsman Chemical. The glass fiber fabric that is in the woven, knitted or braided form was purchased from Wee Tee Tong Pte. Ltd.

The epoxy resin was mixed with the accelerator and hardener to form a mixture that was used to impregnate into the glass fiber fabric. The impregnated fabrics are then stacked to obtain between 1 to 6 plies while the total glass fiber content is about 70 vol %. The laminated material (pre-preg), was left at room temperature to B-stage for 24 hours, after which it has to be stored at temperatures below −4° C. The pre-preg will have to be thawed to room temperature prior to molding into samples. The pre-preg was laid on a stainless steel plate and vacuum bagging was performed to remove excess resin and air bubbles. The material was cured under a pressure about 1 atm (101.3 kpa) at 180° C. for 3 hours. The cured laminate was cut into test samples with a dimension of 175 mm*25 mm*2 mm (L*W*T).

### Example 2

### Preparation of Pre-Preg Laminate with Holes

The cured laminate in Example 1 was cut into testing specimens with a dimension of 250 mm*36 mm*2 mm (L*W*T). A hole with a diameter of 6 mm was drilled in the center of the testing specimen. Two pieces of sand paper with length of 25 mm and thickness of 1 mm were used as friction tabs.

### Example 3

### Preparation of PP (Comparative Example)

The polypropylene copolymer manufactured by North Sea Plastic was used to mold sheets with a thickness of 3.1 mm. The PP sheet was cut into test samples with a dimension of 175 mm*25 mm*2 mm (L*W*T).

### Example 4

### Preparation of PP with Holes (Comparative Example)

The PP sheet in Example 3 was cut into test sample with a dimension of 250 mm*36 mm*2 mm (L*W*T). A hole with a diameter of 6 mm was drilled in the center of the test sample.

### Example 5

### Measurement of Tensile Properties

The tensile properties of the molded articles with and without drilled holes are measured according to the ASTM D3039 and D5766 standards respectively in order to consider whether the material is suited for making body braces with ventilation holes. The testing was carried out at room temperature. Crosshead speed was controlled at 2 mm/min.

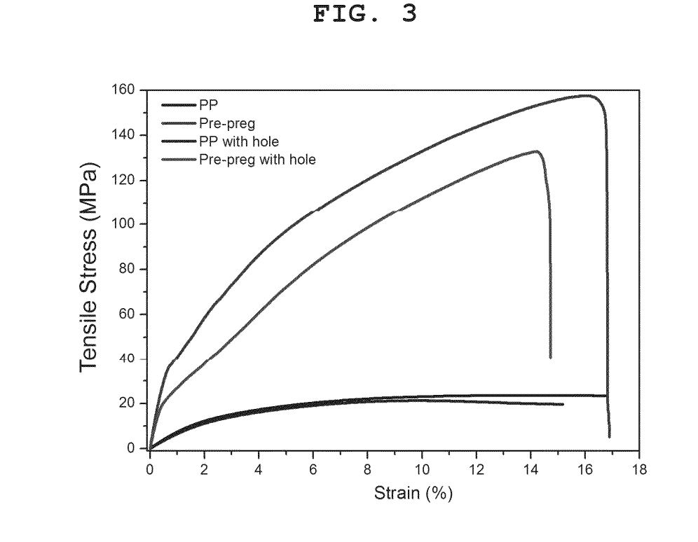

The stress-strain curves are shown in FIG. 3 and results are summarized in Table 1.

TABLE 1
Tensile properties of PP and pre-impregnated
laminate with and without holes

| | Modulus | Strength | Elongation at |
|---|---|---|---|
| Samples | (GPa) | (MPa) | Break (%) |
| Pre-preg Laminate | 7.53 | 157.5 | 16.7 |
| Pre-preg Laminate | 6.44 | 132.9 | 14.4 |
| with hole | | | |
| PP | 0.88 | 23.6 | — |
| PP with hole | 0.79 | 21.3 | — |

The test results indicated that the holes on laminate articles will not significant decrease their mechanical properties. The Young's modulus directly indicates the rigidity of a material, which is a key property to determine the supporting and protecting effect of a body brace. For both pre-impregnated (pre-preg) laminate and PP materials, introduction of a drilled hole decreases the mechanical properties (Young's modulus and tensile strength). Thus, it is hardly possible to drill ventilation holes on the body brace made of PP due to the weak mechanical property of PP. However, the pre-impregnated laminate article still possess a high modulus (7.53 GPa) and a high strength (157.5 MPa) because of the integrated structure of reinforcing fabric and the strong adhesion between fabric and epoxy resin. Even with a drilled hole, the pre-impregnated laminate article still possesses a high modulus (6.44 GPa) and a high strength (132.9 MPa), which are much higher than those of PP. Therefore, the much better mechanical properties of laminate articles allows the body brace made of them to be drilled with holes in contrast to those made of PP. Through simulation, it can be approved that, after being drilled with more holes for effective ventilation, the laminate article still has higher Young's modulus and tensile strength than PP, indicating that the laminate article with holes can be used to manufacture body braces with a qualified mechanical property.

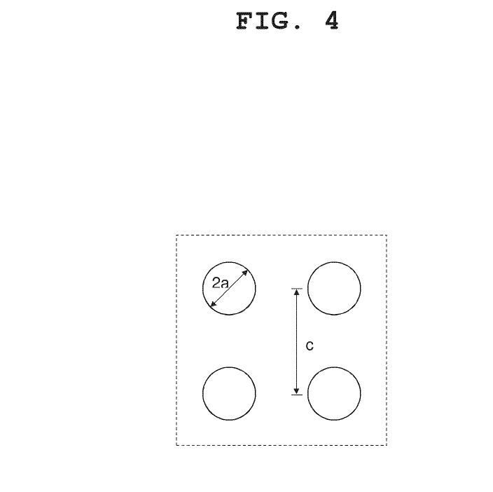

Mechanical property simulation was performed to compare the performance of the laminate to conventional PP materials, especially when circular holes are present in the structure. For the plate with periodic circular holes, as shown in FIG. 4, with the representative area A=4 c² , and the ratio a²/A=(a/c), the tensile modulus of the plate can be predicted by the formula (I)

$$E = \frac{{E}_{0}}{1 + λ H} , \\ H = 3 {π ( \frac{a}{c} )}^{2} , \qquad ( I )$$

wherein E₀ is the plate modulus without a hole, and A is a non-dimensional parameter introduced to adjust the model by marching the testing results.

The testing results are given in Table 2. The dimension of the samples without hole is: thickness 2 mm, length 250 mm, and width 25 mm. For the samples with a hole, the geometry of the plate is given by thickness 2 mm, length 250 mm, and width 36 mm. The hole is located in the center of the tested sample with a diameter of 6 mm.

TABLE 2
Tensile properties of different samples

| | Modulus | Strength | Elongation at |
|---|---|---|---|
| Samples | (GPa) | (MPa) | Break (%) |
| PP | 0.88 | 23.6 | |
| Prepreg | 7.53 | 157.5 | 16.7 |
| PP with hole | 0.79 | 21.3 | |
| Prepreg with | 6.44 | 132.9 | 14.4 |
| hole | | | |

To match the testing results, by choosing λ=2.6, we obtain from (I) that for a/c= 3/36=0.083, Eₗₐₘᵢₙₐₜₑ=6.44 GPa and Eₚₚ=0.76 GPa. It is seen that the relation (I) with λ=2.6 can match the testing results well.

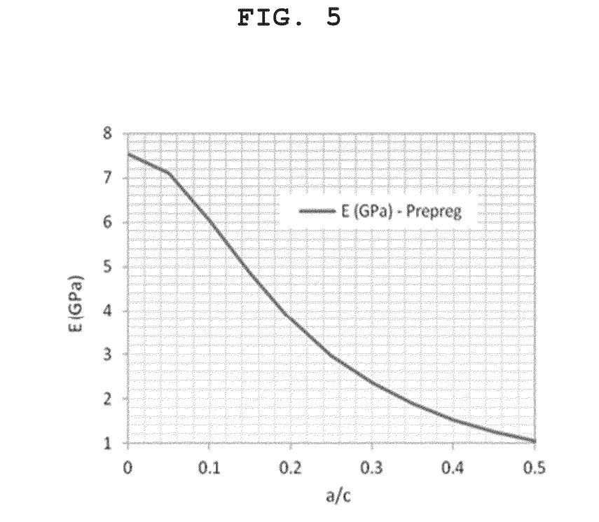

FIG. 5 shows the changes of the equivalent tensile modulus of Prepreg with periodic holes based on the relation of formula (II):

$$E = {E}_{0} / [ 1 + 3 {π ( \frac{a}{c} )}^{2} \times 2.6 ] \qquad ( II )$$

It can be seen from FIG. 5 that, if a person skilled in the art wants the effective tensile modulus of pre-preg laminate with periodic holes being twice times the value of the tensile modulus of PP without holes (i.e. E=2 GPa), then it can be concluded from FIG. 5 that a/c must equal 0.34.

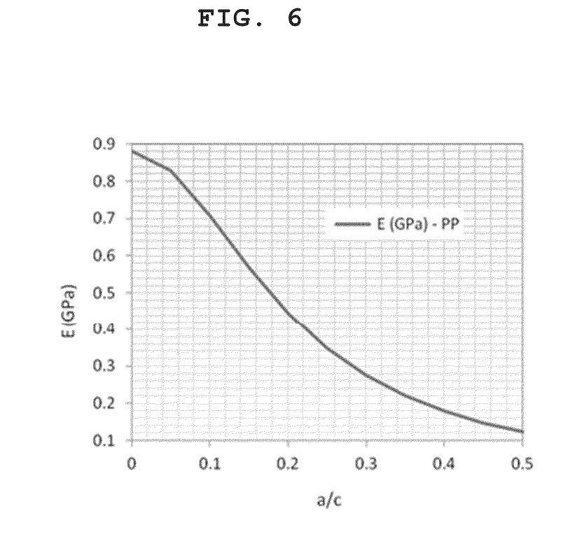

For comparison, the changes of the equivalent tensile modulus of PP with periodic holes are plotted in FIG. 6.

### APPLICATIONS

The disclosed laminate allows for the manufacturing of molded articles with improved mechanical strength. Due to the improved mechanical strength, thin molded articles with holes can be made. The laminate can be molded into any desirable shape to form a rigid shell with a soft foam lining. Such molded article may have numerous uses for which can be mentioned the use as a brace for scoliosis, a prosthetic, a sport protector or a safety device.

The articles with holes allow the manufacturing of devises with good ventilation as needed for example in the field of body braces that cover a large body area. The laminates according to the invention further lead to molded articles wherein a foam layer shows a very strong adhesion to the reinforced polymer shell. The laminates can be used to make devices which need resistance against wear and tear problems.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

What is claimed is:

1. A laminate for making a molded article comprising at least one fiber reinforcement impregnated with a resin matrix as a first layer and a foam as a second layer.

2. The laminate according to claim 1, wherein the first layer consists of multiple layers of fiber reinforcement impregnated with the resin matrix.

3. The laminate according to claim 1, wherein the foam layer is laminated to the first layer using an adhesive layer.

4. The laminate according to claim 3, wherein the adhesive layer is made from a nano-silica based nanocomposite.

5. The laminate according to claim 1, wherein the material of the fiber reinforcement is selected from a carbon, glass, para-aramid synthetic or polymer fibers.

6. The laminate according to claim 1, wherein the resin matrix is an epoxy resin.

7. The laminate according to claim 1, wherein the resin matrix additionally comprises a filler.

8. The laminate according to claim 1, wherein the laminate has holes.

9. The laminate according to claim 8, wherein the holes have a size of about 0.1 to 10 mm.

10. A process for making a laminate according to claim 1, which comprises the following steps:
(a) immersing the fiber reinforcement into the resin matrix,
(b) impregnating the reinforcement,
(c) optionally applying an adhesive to a foam or the impregnated reinforcement, and
(d) attaching the impregnated reinforcement to the foam.

11. A process for making a molded article which comprises the following steps:
(a) exposing the laminate according to claim 1 to a mold of well-defined shape,
(b) applying a pressure to the laminate,
(c) curing the laminate.

12. The process according to claim 11, wherein the pressure is achieved by a vacuum.

13. The process according to claim 12, wherein the vacuum is induced inside a bagging film.

14. The process according to claim 13, wherein a breather material linked to the vacuum port is used between the bagging film and the laminate.

15. The process according to claim 14, wherein a release film is inserted between the breather material and the laminate.

16. The process according to claim 11, further comprising a step of drilling or punching holes into the molded article after the curing step.

17. A molded article obtainable by molding a laminate according to claim 1.

18. A molded article obtainable by molding a laminate according to claim 4.

19. A method of using the molded article according to claim 17 or 18 as a brace for scoliosis, a prosthetic, a sport protector or a safety device.
